(19) United States
(12) Patent Application Publication
(10) Pub. No.: US 2015/0058307 A1
(43) Pub. Date: Feb. 26, 2015

(54) DEVICE FOR RAPID PROVISION OF INFORMATION

(71) Applicant: QWANT, PARIS (FR)

(72) Inventor: Eric Leandri, Paris (FR)

(73) Assignee: QWANT, PARIS (FR)

(21) Appl. No.: 14/390,775

(22) PCT Filed: Mar. 15, 2013
(86) PCT No.: PCT/FR2013/050536

§ 371 Date: Oct. 4, 2014

(30) Foreign Application Priority Data
Apr. 4, 2012 (FR) 12 53085
Aug. 27, 2012 (FR) 12 58009
Aug. 27, 2012 (FR) 12 58010
Aug. 27, 2012 (FR) 12 58011

(51) Int. Cl. G06F 17/30

(52) U.S. Cl. CPC G06F 17/30864
USPC 707/706

(57) ABSTRACT

A system of rapid provision of relevant information. A search context is determined as a function of a combination of keywords inputted by a user. Pages accessible on a network and having at least one word associated with one of the keywords are searched. A result context is determined as a function of the content of the page. The copying of an item of information from an information source accessible on a network to another information source accessible on the network is determined. The source from which the information is copies assigned a higher weight than the source where a copy of the information is placed. The results of the search is hierarchized as a function of the matching of the context of the search, of the context of each result of the search and of the weight of the source. The hierarchized results are displayed.

### FIELD OF THE INVENTION

The present invention concerns a method and a device for the rapid provision of information. It applies, in particular, to search engines on computer networks, such as the Internet.

### DESCRIPTION OF RELATED ART

The accessibility and intelligibility of information have become major technical problems now that this information is available on computer networks such as the Internet.

A keyword search by the most well-known search engines, for example the one described in document WO 2007/046830, gives a series of responses, each response taking the form of a title associated to a hyperlink, an extract of the page accessible through this link, which comprises several of the selected keywords and, possibly, a date and a URL address (acronym for Uniform Resource Locator). However, the order of this series of responses depends on the choice made by the search engine's managers, for example dictated by business relations or the effects of competition with social sites. Thus, opinions are emphasized, as well as multiple copies of information, at the expense of useful, objective information, or initial information before being recopied.

In addition, to discover the information available and assign keywords to it, a robot browses the websites, one by one, in a cycle of several weeks.

Therefore, the information thus available is generally neither sufficiently recent nor sufficiently relevant.

### SUMMARY OF THE INVENTION

The aim of the present invention is to remedy these disadvantages.

To this end, the present invention envisages, according to a first aspect, a method for the rapid provision of relevant information, that comprises:
a step of inputting a plurality of keywords by a user;
a step of determining a search context as a function of the input combination of keywords;
a step of searching for pages accessible on a network and comprising at least one word associated with one said keyword;
a step of determining a result context as a function of the content of the page;
a step of determining the copying of an item of information from an information source accessible on a network to another information source accessible on said network;
a step of assigning, to the source from which said information is copied, a higher weight than the source where a copy of said information is placed;
a step of hierarchizing the results of the search as a function of the matching of the context of the search and of the context of each result of the search and of the weight of the source; and
a step of displaying hierarchized results.

Thanks to these provisions,
the user does not have to specify the specific meaning of a word when that word has several meanings;
a source, for example a site or an author of messages on social networks, is automatically assigned a higher weight than a site or another author copying a piece of content. It is noted that the weight associated to the site is applied, at least partially, to all the pages of the site. Similarly, the weight associated to an author is applied, at least partially, to all the messages emitted by that author.

Because of the link between the weight and the display hierarchy, original sources of content are favored.

In some embodiments, the step of determining the copying of an item of information comprises:
a step of memorizing the information, a time-stamp associated with said information and the source of said information from which access to said information was obtained; and
a step of comparing memorized information to detect similarities between the information and, if similarities between two items of information are detected,
a step of assigning a higher weight to the source associated to the earliest time-stamp.

In some embodiments, during the comparison step, similarities are detected as a function of the number of successive similar characters between said items of information.

In some embodiments, during the comparison step, similarities are detected as a function of a level of similar words between said items of information.

In some embodiments, during the comparison step, similarities are detected as a function of the number of successive similar characters between said items of information and the distance between said similar words.

Thanks to each of these provisions, copies of items of information are detected rapidly.

In some embodiments, during the step of assigning to the source from which the information was copied, the weight assigned to the source is an increasing, non-constant function of the number of copies of the item of information determined during the copy determination step.

Thus, content authors who have many followers provide a higher weight to their messages than authors who have no or few followers.

Thanks to these provisions, a source, for example a site or an author of messages on social networks, is automatically assigned a higher weight than a site or another author copying a piece of content. It is noted that the weight associated to the site is applied, at least partially, to all the pages of the site. Similarly, the weight associated to an author is applied, at least partially, to all the messages emitted by that author.

Because of the link between the weight and the display hierarchy, original sources of content are therefore favored.

In some embodiments, the method that is the subject of the invention comprises:
a step of creating groups of sources of information accessible on a network;
a step of inputting at least one main keyword by a user;
a step of searching for pages in said information sources and comprising at least one word associated with one said main keyword;
a step of grouping results of the search as a function of groups of information sources from which the results are obtained;
a step of hierarchizing the results of the search, in each group of results matching the various groups of information sources as a function of the weight of the source; and
a step of separately displaying each group of results.

Thanks to these provisions, the user can view in parallel results that come from on-line information sites, on-line commerce sites, social network sites, and other websites, for example.

In some embodiments, each group of information sources corresponds to a group of sites of similar activities.

In some embodiments, the step of creating groups of information sources comprises a step of memorizing groups of sites in a correlated semantic index, the step of grouping results utilizing said groups conserved in an index.

In some embodiments, the creation of groups of sites is a function of information present on said sites, the step of grouping results utilizing said groups of sites.

For example, the presence of a large number of prices on a site allows it to be grouped with on-line commerce sites.

In some embodiments, during the step of selecting an additional item of information, the user selects said additional item of information with regard to a group of results, and, during the second step of hierarchizing the results of the search, only the results of said group of results are hierarchized.

Thanks to these provisions, the user selects a type of information source. In addition, the method is especially rapid since the second hierarchization step only involves the results of a single group of results.

In some embodiments, during at least one hierarchization step, a weighting of main keywords is utilized.

In some embodiments, during at least one hierarchization step, the additional item of information matches at least one keyword with a lower weight than the weight of each main keyword.

In some embodiments, during the step of selecting an additional item of information, the user inputs at least one secondary keyword, each secondary keyword having, during the second hierarchization step, a lower weight than each main keyword.

In some embodiments, the method that is the subject of the present invention comprises a step of categorization as a function of the content of the result pages of the search step and, during the step of selecting an additional item of information, the user selects a category, a second hierarchization step giving a higher hierarchical level to pages matching the category selected.

In some embodiments, the method that is the subject of the present invention comprises a step of categorization as a function of the server hosting each result pages of the search step and, during the step of selecting an additional item of information, the user selects a server category, a second hierarchization step giving a higher hierarchical level to pages matching the category selected.

It is noted that each server category can be identified by a country in which the server is located.

In some embodiments, during the step of selecting an additional item of information, the user selects a filter and, during the second hierarchization step, the pages not matching the filter have a lower weight than the pages matching the filter.

In some embodiments, during the step of selecting an additional item of information, the user selects a search result, the method comprising a step of determining secondary keywords as a function of the result selected and, during the second hierarchization step, each secondary keyword has a lower weight than the weight of each main keyword.

In some embodiments, the method that is the subject of the invention comprises:
a step of grouping results of the search as a function of groups of information sources where the search is carried out;
a step of hierarchizing the results of the search, in each group of results corresponding to the various groups of sites; and
a step of separately displaying each group of results.

Thanks to these provisions, the user can view in parallel results that come from on-line information sites, on-line commerce sites, social network sites, and other websites, for example.

In some embodiments, each information source group corresponds to a group of sites of similar activities.

In some embodiments, the method that is the subject of the present invention comprises a step of grouping sites as a function of information present on said sites, the step of grouping results utilizing said groups of sites.

For example, the presence of a large number of prices on a site allows it to be grouped with on-line commerce sites.

The present invention envisages, according to a second aspect, a device for the rapid provision of relevant information comprising a means of inputting a plurality of keywords by a user, characterized in that it also comprises:
a means of determining a search context as a function of the input combination of keywords;
a means of searching for pages accessible on a network and comprising at least one word associated with one said keyword;
a means of determining a result context as a function of the content of the page;
a means of determining the copying of an item of information from an information source accessible on a network to another information source accessible on said network;
a means of assigning, to the source from which said information is copied, a higher weight than the source where a copy of said information is placed;
a means of hierarchizing the results of the search as a function of the matching of the context of the search and of the context of each result of the search and of the weight of the source; and
a means of displaying hierarchized results.

As the particular features, advantages and aims of this device are similar to those of the method that is the subject of the first aspect of the present invention, they are not repeated here.

The present invention envisages, according to a third aspect, a method for the rapid provision of relevant information, that comprises:
a step of inputting at least one main keyword by a user;
a step of searching for pages accessible on a network and comprising at least one word associated with one said main keyword;
a first step of hierarchizing the results of the search;
a step of displaying results from said search step having a high hierarchical level in the first hierarchization step;
a step of selecting an additional item of information by said user;
a second step of hierarchizing the results of the search as a function of said additional item of information; and
a step of displaying results from said search step having a high hierarchical level in the second hierarchization step.

Thanks to these provisions, the user can progressively refine the search to rapidly obtain the display of the relevant information that he is searching for.

According to particular features, during at least one hierarchization step, a weighting of main keywords is utilized.

According to particular features, during at least one hierarchization step, the additional item of information matches at least one keyword with a lower weight than the weight of each main keyword.

According to particular features, during the step of selecting an additional item of information, the user inputs at least one secondary keyword, each secondary keyword having, during the second hierarchization step, a lower weight than each main keyword.

According to particular features, the method that is the subject of the present invention comprises a step of categorization as a function of the content of the result pages of the search step and, during the step of selecting an additional item of information, the user selects a category, a second hierarchization step giving a higher hierarchical level to pages matching the category selected.

According to particular features, the method that is the subject of the present invention comprises a step of categorization as a function of the server hosting each result pages of the search step and, during the step of selecting an additional item of information, the user selects a server category, a second hierarchization step giving a higher hierarchical level to pages matching the category selected.

It is noted that each server category can be identified by a country in which the server is located.

According to particular features, during the step of selecting an additional item of information, the user selects a filter and, during the second hierarchization step, the pages not matching the filter have a lower weight than the pages matching the filter.

According to particular features, during the step of selecting an additional item of information, the user selects a search result, the method comprising a step of determining secondary keywords as a function of the result selected and, during the second hierarchization step, each secondary keyword has a lower weight than the weight of each main keyword.

The present invention envisages, according to a fourth aspect, a device for the rapid provision of relevant information, that comprises:
a means of inputting at least one main keyword by a user;
a means of searching for pages accessible on a network and comprising at least one word associated with one said main keyword;
a first means of hierarchizing the results of the search;
a means of displaying results from the search having a high hierarchical level assigned by the first hierarchization means;
a means of selecting an additional item of information by said user;
a second means of hierarchizing the results of the search as a function of said additional item of information; and
a means of displaying results from the search having a high hierarchical level assigned by the second hierarchization means.

As the particular features, advantages and aims of this device are similar to those of the method that was the subject of the third aspect of the invention, they are not repeated here.

The present invention envisages, according to a fifth aspect, a method for the rapid provision of relevant information, that comprises:
a step of creating groups of sources of information accessible on a network;
a step of inputting at least one main keyword by a user;
a step of searching for pages in said information sources and comprising at least one word associated with one said main keyword;
a step of grouping results of the search as a function of groups of information sources from which the results are obtained;
a step of hierarchizing the results of the search, in each group of results corresponding to the various groups of information sources; and
a step of separately displaying each group of results.

Thanks to these provisions, the user can view in parallel results that come from on-line information sites, on-line commerce sites, social network sites, and other websites, for example.

In some embodiments, each group of information sources corresponds to a group of sites of similar activities.

In some embodiments, the step of creating groups of information sources comprises a step of memorizing groups of sites in a database, the step of grouping results utilizing said groups conserved in a database.

In some embodiments, the creation of groups of sites is a function of information present on said sites, the step of grouping results utilizing said groups of sites.

For example, the presence of a large number of prices on a site allows it to be grouped with on-line commerce sites.

The present invention envisages, according to a sixth aspect, a device for the rapid provision of relevant information, that comprises:
a means of creating groups of sources of information accessible on a network;
a means of inputting at least one main keyword by a user;
a means of searching for pages in said information sources and comprising at least one word associated with one said main keyword;
a means of grouping results of the search as a function of groups of information sources from which the results are obtained;
a means of hierarchizing the results of the search, in each group of results corresponding to the various groups of information sources; and
a means of separately displaying each group of results.

As the particular features, advantages and aims of this device are similar to those of the method that was the subject of the fifth aspect of the invention, they are not repeated here.

The present invention envisages, according to a seventh aspect, a method for the rapid provision of relevant information, that comprises:
a step of determining the copying of an item of information from an information source accessible on a network to another information source accessible on said network;
a step of assigning, to the source from which said information is copied, a higher weight than the source where a copy of said information is placed;
a step of searching for pages accessible on a network and comprising at least one word associated with one said main keyword;
a step of hierarchizing the results of the search, utilizing said weight of the source; and
a step of displaying hierarchized results.

Thanks to these provisions, a source, for example a site or an author of messages on social networks, is automatically assigned a higher weight than a site or another author copying a piece of content. It is noted that the weight associated to the site is applied, at least partially, to all the pages of the site. Similarly, the weight associated to an author is applied, at least partially, to all the messages emitted by that author.

Because of the link between the weight and the display hierarchy, original sources of content are therefore favored.

In some embodiments, the step of determining the copying of an item of information comprises:
a step of memorizing the information, a time-stamp associated with said information and the source of said information from which access to said information was obtained; and
a step of comparing memorized information to detect similarities between the information and, if similarities between two items of information are detected, a step of assigning a higher weight to the source associated to the earliest time-stamp.

In some embodiments, during the comparison step, similarities are detected as a function of the number of successive similar characters between said items of information.

In some embodiments, during the comparison step, similarities are detected as a function of a level of similar words between said items of information.

In some embodiments, during the comparison step, similarities are detected as a function of the number of successive similar characters between said items of information and the distance between said similar words.

Thanks to each of these provisions, copies of items of information are detected rapidly.

In some embodiments, during the step of assigning to the source from which the information was copied, the weight assigned to the source is an increasing, non-constant function of the number of copies of the item of information determined during the copy determination step.

Thus, content authors who have many followers provide a higher weight to their messages than authors who have no or few followers.

The present invention envisages, according to an eighth aspect, a device for the rapid provision of relevant information, that comprises:
a means of determining the copying of an item of information from an information source accessible on a network to another information source accessible on said network;
a means of assigning, to the source from which said information is copied, a higher weight than the source where a copy of said information is placed; and
a means of searching for pages accessible on a network and comprising at least one word associated with one said main keyword;
a means of hierarchizing the results of the search; utilizing said weight of the source; and
a means of displaying hierarchized results.

As the particular features, advantages and aims of this device are similar to those of the method that was the subject of the seventh aspect of the invention, they are not repeated here.

The present invention envisages, according to a ninth aspect, a method for the rapid provision of relevant information, that comprises:
a step of inputting a plurality of keywords by a user;
a step of determining a search context as a function of the input combination of keywords;
a step of searching for pages accessible on a network and comprising at least one word associated with one said keyword;
a step of determining a result context as a function of the content of the page;
a step of hierarchizing the results of the search as a function of the matching of the context of the search and of the context of each result of the search and
a step of displaying hierarchized results.

Thanks to these provisions, the user does not have to specify the specific meaning of a word when that word has several meanings.

The present invention envisages, according to a tenth aspect, a device for the rapid provision of relevant information, that comprises:
a means of inputting a plurality of keywords by a user;
a means of determining a search context as a function of the input combination of keywords;
a means of searching for pages accessible on a network and comprising at least one word associated with one said keyword;
a means of determining a result context as a function of the content of the page;
a means of hierarchizing the results of the search as a function of the matching of the context of the search and of the context of each result of the search and
a means of displaying hierarchized results.

As the particular features, advantages and aims of this device are similar to those of the method that was the subject of the ninth aspect of the invention, they are not repeated here.

The principal or particular features of the various aspects of the present invention are particular features of the other aspects of the present invention. These principal and particular characteristics of the various aspects of the present invention are preferably combined to obtain all of the advantages described for each of these aspects, in a single search engine.

### BRIEF DESCRIPTION OF THE DRAWINGS

Other advantages, aims and particular features of the present invention will become apparent from reading the description that will follow, made, as a non-limiting example, with reference to the drawings included in an appendix, wherein:

FIG. 1 represents, schematically, an interface utilized by a particular embodiment of the method that is the subject of the present invention;

FIG. 2 represents, schematically, a network of servers; and

FIG. 3 represents, in the form of a logical diagram, steps utilized in an embodiment of the search method that is the subject of the present invention;

FIG. 4 represents, in the form of a logical diagram, steps utilized during one of the steps illustrated in FIG. 3.

### DESCRIPTION OF EMBODIMENTS OF THE INVENTION

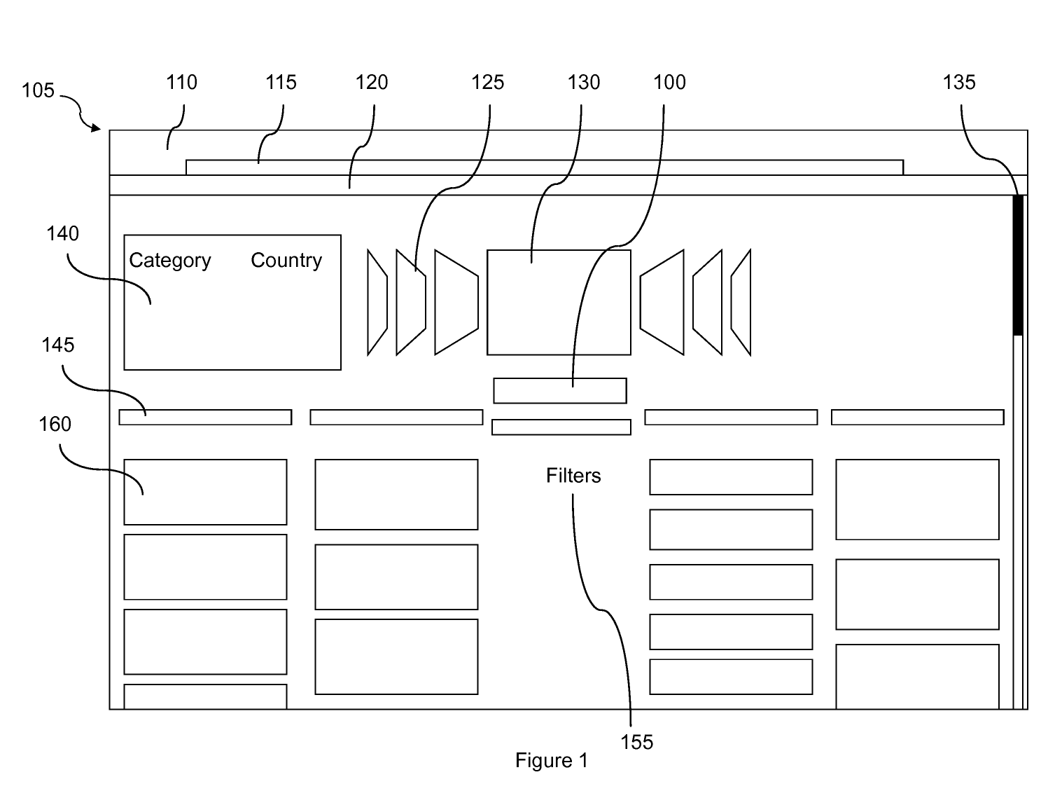

FIG. 1 shows a user interface 105, as it appears on the screen of a terminal, e.g. a personal computer, smartphone or tablet. In this interface there is, at the top, a bar 110 associated to the browser with which, on the web, the interface 105 is accessed, an address bar 115, which represents the electronic address (“URL”) of the server providing the interface 105, and a bar 120 of drop-down menus and/or icons.

In the main window, oblique dynamic previews 125 of the pages accessible with the links of the responses from the search are shown. These previews are animated. For example, the preview makes it possible to see whether a video or animation is on each page previewed. The term “oblique” here means that the pages are represented by trapezoids that become narrower, laterally, as they get farther from the center of the interface 105.

At the center of the previews 125 is a dynamic preview 130 of a selected page. This page is selected by passing the cursor of a pointing device, e.g. a mouse, over one of the dynamic previews. In this way, the user can scroll, laterally, through the pages accessible with the links of the responses from the search. By clicking on one of these pages, the user causes a new tab or a new window to be opened and accesses the display, in large format, of the page selected. Alternatively, by clicking on one of the previewed pages, the tab displaying the search results is replaced by a tab displaying the page selected.

Below the preview 130, there is an area 100 for inputting at least a main keyword. It is in this area 100 that the user inputs one or more keywords. The rectangular button (not referenced) located below the area 100, as well as the keyboard's “enter” key, allows the search to be launched.

To the left of the previews 125 there is a window 140 displaying dynamic categories and dynamic countries. The dynamic categories are constituted by identifying, in the responses matching the main keywords, the words that are found neither rarely nor very commonly. For example, the categories are constituted of words found in less than 70% of the responses, except for words in a low significance word list, such as “since”, “sometimes”, etc., and in more than 20% of the pages. The countries are selected, for example, by taking the nine countries in which there are the largest numbers of servers hosting the response pages.

It is noted that the categories and the countries correspond to two categorizations of content sources searched for:
in the first, categorization is performed as a function of the content of the result pages of the search step, the hierarchical level being higher for the pages matching the category selected;
in the second, categorization is performed as a function of the server hosting each result page of the search step, the hierarchical level being higher for the pages matching the category selected.

It is noted that each server category can be identified by a country in which the server is located. In a variant, the country is determined as a function of the site's domain name, its address on the network and/or the terminator routers allowing the content hosted on this server to be accessed.

Of course, when the search specification is modified, by replacing keywords in the area 100 or by an additional search definition, as described below, the lists of categories and countries are automatically changed. The search performed on the keywords input is performed not only on these keywords but also on close keywords such as, for example, the feminine or plural of a determinant (e.g. inputting “candidat” also leads to a search on the keywords “candidate”, “candidats”, and “candidates”) and on associated words (“candidature”). Searching with synonyms (“applicant”) is added to this. For this, a dictionary is utilized that contains words that are related or synonyms and/or a cluster of words, and in which the distance between the words is determined dynamically with the responses to the searches carried out by the users.

In addition, the distance, relative to the start of the text, of each keyword present on a page is used as an indicator of relevance: the closer the keyword is to the beginning of the text, the more relevant the response is considered to be. The distance between two keywords is used in the same way: the closer they are in the text of a page, the more relevant this page is considered to be.

By clicking on one of these categories or a country name displayed in the window, the search is changed and/or the results are sorted so that only the responses that include the words defined by the selected category or the pages hosted in the selected country are displayed.

To the right of the interface 105, a scroll bar 135 represents the portion of the interface 105 that is displayed on the screen, in a known way. By selecting and moving this scroll bar the user makes the interface 105 scroll vertically, from top to bottom.

Four areas 145 show four search groups and are above four groups 160 of responses. For example, the leftmost area 145 shows the Internet (“web”) and specifies that the responses of the group 160 located below this area 145 are web pages. The area 145 to the left of the entry area 100 shows the chronology (“chrono”) and specifies that the responses of the group 160 located below this area 145 are the latest items of information published on newspaper sites. The area 145 to the right of the entry area 100 shows the social networks (“social)” and specifies that the responses of the group 160 located below this area 145 are the latest items of information published on social network sites. Preferably, an indication of the time that has elapsed since the publication of the response is associated to the response. Finally, the rightmost area 145 shows the shopping chronology (“shopping”) and specifies that the responses of the group 160 located below this area are the results obtained on commerce sites.

By default, the responses that have been updated are shown at the top of the groups 160, at least for the groups of results 160 corresponding to social networks and on-line newspapers. The groups of results 160 corresponding to the Internet and on-line commerce sites can be organized as a function of the relevance of the responses, in particular by utilizing weighting of the keywords input explicitly (by being input in one of the areas 100 or 145) or implicitly (by selecting a category or country or by selecting a result, as described below).

By inputting at least one keyword in one of the areas 145, the user starts a search, among the search results, in the group 160 corresponding to this area 145, for responses comprising each new keyword input. Thus, each keyword input in the entry area 100 has a weight, in the search, that is higher than that of the word input in the area 145. It is noted that the other areas 145 and groups 160 are not affected by inputting a keyword in an area 145.

Thus, in some embodiments, during the step of selecting an additional item of information, the user selects the additional item of information with regard to a group of results, and, during a second step of hierarchizing the results of the search, preferably only the results of said group of results are hierarchized.

A window 155 located below the entry area 100 shows types of filters that the user can apply to the results of the search in order to improve the relevance of the results displayed. For example, these filters are “all”, “Facebook” (registered trademark), “twitter” (registered trademark), “YouTube” (registered trademark), “Sort”, “Newest”, “Oldest”, “Display”, “Grid” and “Lines”. These filters perform sorts, except for “all”, which is the default value, no sort:
selecting the “Facebook” sort filter leads to only results coming from the “Facebook” site being displayed in the group of results from social networks;
selecting the “Twitter” sort filter leads to only results coming from the “Twitter” site being displayed in the group of results from social networks;
selecting the “YouTube” sort filter leads to only results coming from the “YouTube” site being displayed in the group of results from social networks;
selecting the “Sort” sort filter allows access to sort filters other than those shown in the window 155 and to sort parameters wherein the value can be changed;
selecting the “Newest” sort filter, the default value, leads to the most recently updated pages being displayed in the groups of search results 160;
selecting the “Oldest” sort filter, the default value, leads to the earliest updated pages being displayed in the groups of search results 160;
selecting the “Display” sort filter allows access to display types other than those shown in the interface 105 shown in FIG. 1 and to display parameters wherein the value can be changed;
selecting the “Grid” sort filter, the default value, allows the results to be displayed in the form of a grid, as shown in FIG. 1;
selecting the “Lines” sort filter allows the results obtained to be displayed line by line, as in a conventional search engine. The type of sort is, for example, suited to smartphones having a screen relatively smaller than that of PC tablets and personal computers.

Thus, the user can choose, in windows 140 or 155 or in areas 145, to add to the sort initially performed by inputting keywords in the entry area 100.

When the search is refined in this way, or when one of the search results is clicked on, the significant words in the title of the selected page automatically form additional keywords, with a lower weight than the keywords input in the entry area 100 or in the area 145, and the search results display is modified to takes these weights into account.

Finally, a popularity level of the responses, as a function of the selections made by the previous users who performed the same search or a similar search, and the recommendations made on the social networks by the users, is utilized. These recommendations thus influence each of the columns since they can concern Internet sites, on-line newspaper sites or on-line commerce sites. Similarly, copies of a tweet (messages sent on the “twitter site) give weight to the original tweet. This copied tweet thus rises in the group 160 of results obtained on the social network sites. Similarly, content authors who have many followers provide a higher weight to their messages than authors who have no followers.

To distinguish the original authors or “leaders” from their followers, information copies are processed to form a tree-structure. This real-time processing produces a history and finds the copies. It thus forms the tree-structure. Following the appearance of information in the virtual world also makes it possible to distinguish the leaders from the followers. The messages sent by the first have a higher weight than those emitted by the second.

Finally, an author's relevance can be known by using his profile on the professional social networks such as LinkedIn or Viadeo (registered trademarks). In this way, the keywords are indexed by concept (e.g. “person”, “company”, “geography” or “country”). Thus, a search on “Victor Hugo” will give results for the author with the same name and will exclude the street names “Victor Hugo”. A contextual analysis is utilized to realize this categorization by concept. Thus, the joint present of “Victor Hugo” and “Miserables” in a page assigns the concept “person” to “Victor Hugo”, whereas the joint presence of “Victor Hugo” and “Butcher” in a page assigns the concept “geography” to “Victor Hugo”.

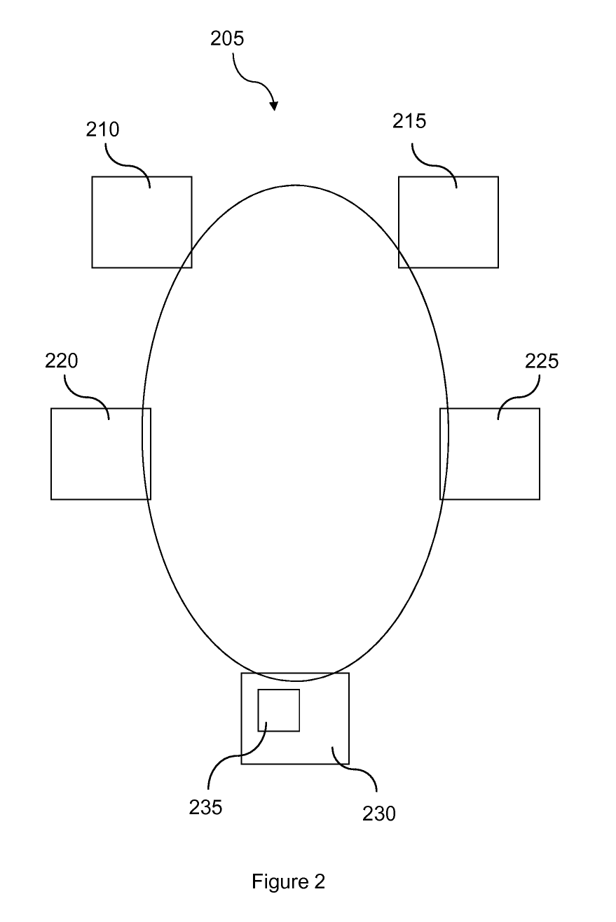

FIG. 2 shows a network 205, for example the Internet, which links together, for example with the Internet Protocol, or “IP”, a consultation terminal 230 equipped with a browser 235, a group of Internet servers 210, a group of on-line newspaper site servers 215, a group of social network servers 220 and a group of on-line commerce sites 225.

When a search is launched by a user, this search is performed, in parallel, on each of the groups 210 to 225 and the corresponding results are displayed in the result groups 160 shown in FIG. 1.

The rest of the description gives other advantages and technical characteristics of various embodiments of the method that is the subject of the invention.

To obtain the results described above, a smart search engine learns from its users:
each new request is added to the previous one and increases the relevance of the results;
the method can comprise using users' data (interests declared on all the social networks) to refine its results and respond to such questions as “Where can I go this evening?”

The method can also comprise scanning and indexing any source of data in real time:
Web (websites, news, photos, videos, etc.)
Social networks
On-line storage spaces (Dropbox, SugarSync, registered trademarks), hard disks, etc.

The method can also comprise setting up and making a platform for exchanges and networking available to users. Just as the search tools are imperfect, “social networking” also has its limitations: the most significant of these comes from the fact that most Internet users do not share the same current interests as their “friends” (or the same search areas). Another major limitation is the fact that, very often, these “friends” are individuals that they scarcely know. Consequently, most of the time, these “friends” cannot contribute to making the result of current searches more relevant whereas many individuals could contribute very relevant results if they could be connected together.

In contrast, a platform implemented with the method that is the subject of the invention makes it possible, whatever the interests and current search areas (search for an event, a product, information about a person, a friend or another) to identify and to connect to any person in the world who has expressed an interest in the topic in question. The method makes it possible to connect the results of searches with people sharing the same areas of interest by processing the information that they have commented on these topics on the social networks.

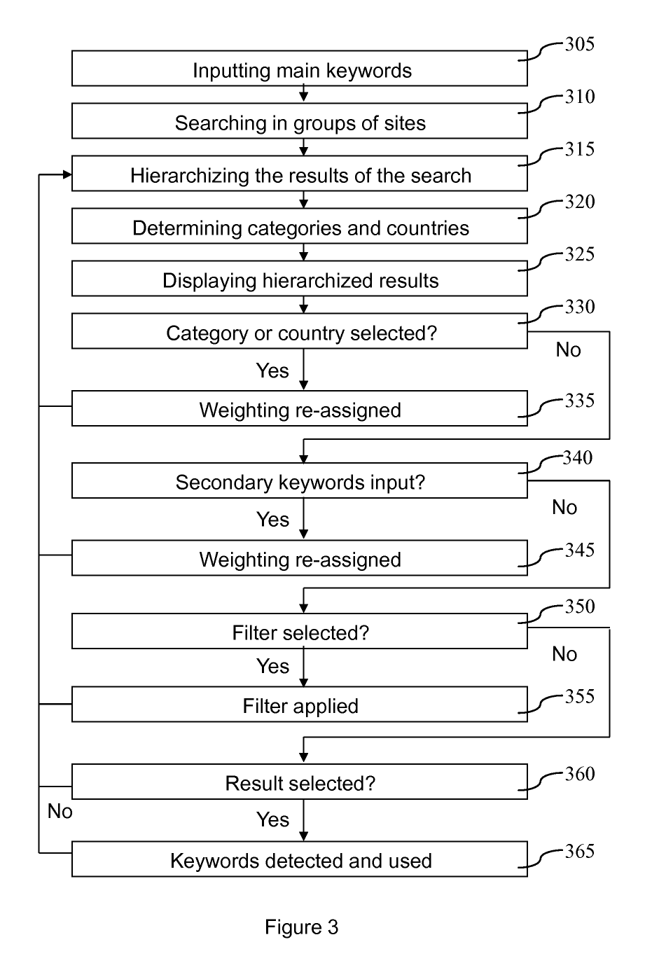

FIG. 3 shows a step 305 of inputting, by a user, at least one keyword referred to as a “main” keyword since its weight is the highest in the searches. Then the user launches the search.

During a step 310, the underlying search engine at the search site performs the search for pages comprising at least one main keyword.

To do this, the search engine separately analyses the content in different groups of sites, for example:
Internet (“web”), where the responses are web pages;
chronology (“chrono”), where the responses are the latest items of information published on newspaper sites;
social networks (“social”, where the responses are the messages published on social network sites; and
commerce (“shopping”), where the responses are obtained on commerce sites.

To separate these searches, the databases of sites in each of the categories are utilized or a contextual analysis is performed (prices are commerce site indicators, for example).

The search performed on the keywords input is performed not only on these keywords but also on close keywords such as, for example, the feminine or plural of a determinant (e.g. inputting “candidat” also leads to a search on the keywords “candidate”, “candidats”, and “candidates”) and on associated words (“candidature”). Searching with synonyms (“applicant”) is added to this. For this, a dictionary is utilized that contains words that are related or synonyms and/or a cluster of words, and in which the distance between the words is determined dynamically with the responses to the searches carried out by the users.

During a step 315, the results of the search are hierarchized for each group of results. Some groups are hierarchized as a function of the relevance of the responses, based on the position and weight of keywords explicitly input, of their associated words (close or synonyms, for example) and of implicit keywords. The distance, relative to the start of the text, of each keyword present on a page is used as an indicator of relevance: the closer the keyword is to the beginning of the text, the more relevant the response is considered to be. The distance between two keywords is used in the same way: the closer they are in the text of a page, the more relevant this page is considered to be. Other groups take into account, in the hierarchization, the time elapsed since the result was put on-line, especially for the “chrono” and “social” groups.

The hierarchization can also use a popularity level of the responses, as a function of the selections made by the previous users who performed the same search or a similar search, and the recommendations made on the social networks by the users. These recommendations thus influence each of the columns since they can concern Internet sites, on-line newspaper sites or on-line commerce sites. Similarly, copies of a tweet (messages sent on the “twitter site) give weight to the original tweet. This copied tweet thus rises in the group 160 of results obtained on the social network sites. Similarly, content authors who have many followers provide a higher weight to their messages than authors who have no followers. To distinguish the original authors or “leaders” from their followers, information copies are processed to form a tree-structure. This real-time processing produces a history and finds the copies. It thus forms the tree-structure. Following the appearance of information in the virtual world also makes it possible to distinguish the leaders from the followers. The messages sent by the first have a higher weight than those emitted by the second.

Finally, an author's relevance can be known by using his profile on the professional social networks such as LinkedIn or Viadeo (registered trademarks).

The hierarchization of the results also takes concepts (e.g. “person”, “company”, “geography” or “country”) into account. The combination of main, or secondary, keywords indicates the concept to which the expected results belong. Analyzing the results also allows a concept to be associated to a result. The results for which the concept matches the concept of the combination of keywords are given a higher rank than the other results.

During a step 320, the search engine determines the categories and countries based on the results of the search. These dynamic categories are constituted by identifying, in the responses matching the main keywords, the words that are found neither rarely nor very commonly. The countries are selected, for example, by taking the nine countries in which there are the largest numbers of servers hosting the response pages. When the search specification is modified, by replacing keywords in the area 100 or by an additional search definition, as described below, the lists of categories and countries are automatically changed.

During a step 325, the results with the highest rank in each of the groups of results are displayed.

During a step 330, it is determined whether the user has selected a category or a country. If yes, during a step 335, the results matching this criterion are given a higher weight than the other results, and one goes back to step 315. In a variant, by clicking on one of these categories or a country name displayed in the window, the search is changed and/or the results are sorted so that only the responses that include the words defined by the selected category or the pages hosted in the selected country are displayed. If the result of step 330 is negative, one goes to a step 340.

During the step 340, it is determined whether the user has input at least one secondary keyword, in an area 145, at the top of a group of results. If yes, during a step 345, each secondary keyword is given a weight, and one goes back to step 315 for the single result group opposite the area 145 used. Thus, by inputting at least one keyword in one of the areas 145, the user starts a search, among the search results, in the group 160 corresponding to this area 145, for responses comprising each new keyword input. Thus, each keyword input in the entry area 100 has a weight, in the search, that is higher than that of the word input in the area 145. It is noted that the other areas 145 and groups 160 are not affected by inputting a keyword in an area 145. If the result of step 340 is negative, one goes to a step 350.

During the step 350, it is determined whether the user has selected a filter, in the window 155. If yes, during a step 355, the selected filter is applied during step 315. In this way, the user can apply a filter to the results of the search in order to improve the relevance of the results displayed. If the result of step 350 is negative, one goes to a step 360.

During the step 360, it is determined whether the user has clicked on a displayed search result. If yes, during a step 365, the significant words in the title of the selected page automatically form additional keywords, with a lower weight than the keywords input in the entry area 100 or in the area 145, and one goes back to step 315. If not, one goes back to step 315.

Thus, by utilizing one of the aspects of the invention, the method realizes a rapid provision of relevant information, comprising:
a step of inputting at least one main keyword by a user;
a step of searching for pages accessible on a network and comprising at least one word associated with one said main keyword;
a first step of hierarchizing the results of the search;
a step of displaying results from said search step having a high hierarchical level in the first hierarchization step;
a step of selecting an additional item of information by said user;
a second step of hierarchizing the results of the search as a function of said additional item of information; and
a step of displaying results from said search step having a high hierarchical level in the second hierarchization step.

In this way, the user can progressively refine the search to rapidly obtain the display of the relevant information that he is searching for.

Preferably, this method also comprises:
a step of inputting at least one main keyword by a user;
a step of searching for pages accessible on a network and comprising at least one word associated with one said main keyword;
a step of grouping results of the search as a function of groups of information sources where the search is carried out;
a step of hierarchizing the results of the search, in each group of results corresponding to the various groups of sites; and
a step of separately displaying each group of results.

Thus, the user can view in parallel results that come from on-line information sites, on-line commerce sites, social network sites, and other websites, for example.

In some embodiments, each information source group corresponds to a group of sites of similar activities.

It is noted that a step of grouping sites can be carried out beforehand in a database, the step of grouping results utilizing said groups conserved in a database.

The step of grouping sites can also be carried out as a function of information present on said sites. For example, the presence of a large number of prices on a site allows it to be grouped with on-line commerce sites.

Preferably, this method also comprises:
a step of determining the copying of an item of information from one source accessible on a network to another;
a step of assigning, to the source from which said information is copied, a higher weight than the source where a copy of said information is placed; and
a step of searching for pages accessible on a network and comprising at least one word associated with one said main keyword;
a step of hierarchizing the results of the search, utilizing said weight of the source; and
a step of displaying hierarchized results.

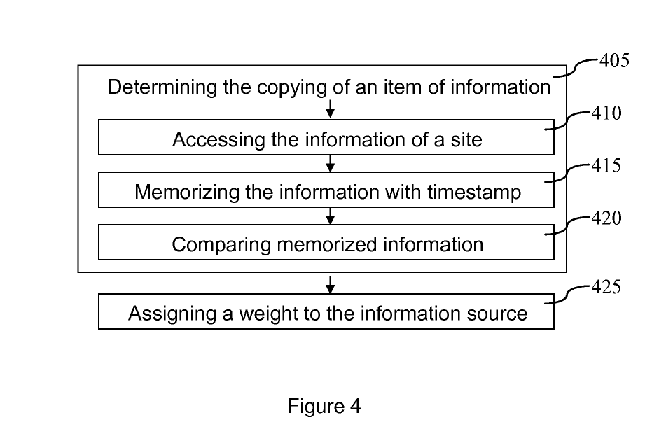

FIG. 4 shows a method for the rapid provision of relevant information, which comprises, firstly, a step 405 of determining the copying of an item of information from an information source accessible on a network to another information source accessible on said network.

It is noted that the source considered here can be a site (e.g. twitter) or an author making information available on a site (author identified by his alias).

In some embodiments, the step 405 of determining the copying of an item of information comprises:
a step 410 of accessing all the information accessible on at least one site;
a step 415 of memorizing the information, a time-stamp associated with said information and the source of said information from which access to said information was obtained;
a step 420 of comparing memorized information to detect similarities between the information and, if similarities between two items of information are detected, during the assignment step 425 detailed below, a higher weight is assigned to the source associated to the earliest time-stamp.

In some embodiments, during the comparison step 420, similarities are detected as a function of the number of successive similar characters between said items of information.

In some embodiments, during the comparison step 420, similarities are detected as a function of a level of similar words between said items of information.

In some embodiments, during the comparison step 420, similarities are detected as a function of the number of successive similar characters between said items of information and the distance between said similar words.

Thanks to each of these provisions, copies of items of information are detected rapidly.

Then a step 425 is carried out of assigning, to the source from which said information is copied, a higher weight than the source where a copy of said information is placed.

In some embodiments, during the step 425 of assigning a weight to the source from which the information was copied, the weight assigned to the source is an increasing, non-constant function of the number of copies of the item of information determined during the copy determination step.

Thus, content authors who have many followers provide a higher weight to their messages than authors who have no or few followers.

In some embodiments, during the weight assignment step 425, the source having supplied the copy of the item of information is assigned a lower weight than sources that have supplied no copy. In this way, copiers are dissuaded from carrying on with the copies.

In some embodiments, during the weight assignment step 425, the weight assigned to a source depends on the type of copy detected. If it is a copy on the same site as the original item of information, the assigned weight will be higher than if it is a copy on another site, and even higher if it is a copy on a site in another category, in another group or of another type than the site from which the item of information was copied.

Thanks to these provisions, a source, for example a site or an author of messages on social networks, is automatically assigned a higher weight than a site or another author copying a piece of content. It is noted that the weight associated to the site is applied, at least partially, to all the pages of the site. Similarly, the weight associated to an author is applied, at least partially, to all the messages emitted by that author.

Because of the link between the weight and the display hierarchy, original sources of content are therefore favored.

A source, for example a site or an author of messages on social networks, is therefore automatically assigned a higher weight than a site or another author copying a piece of content. It is noted that the weight associated to the site is applied, at least partially, to all the pages of the site. Similarly, the weight associated to an author is applied, at least partially, to all the messages emitted by that author. Because of the link between the weight and the display hierarchy, original sources of content are therefore favored.

Preferably, the method also comprises:
a step of inputting a plurality of keywords by a user;
a step of determining a search context as a function of the input combination of keywords;
a step of searching for pages accessible on a network and comprising at least one word associated with one said keyword;
a step of determining a result context as a function of the content of the page;
a step of hierarchizing the results of the search as a function of the matching of the context of the search and of the context of each result of the search and
a step of displaying hierarchized results.

The user does not, therefore, have to specify the specific meaning of a word when that word has several meanings.

To implement the method that is the subject of the present invention, device for the rapid provision of relevant information is utilized, that comprises:
a means of inputting at least one main keyword by a user;
a means of searching for pages accessible on a network and comprising at least one word associated with one said main keyword;
a first means of hierarchizing the results of the search;
a means of displaying results from the search having a high hierarchical level assigned by the first hierarchization means;
a means of selecting an additional item of information by said user;
a second means of hierarchizing the results of the search as a function of said additional item of information;
a means of displaying results from the search having a high hierarchical level assigned by the second hierarchization means;
a means of grouping results of the search as a function of groups of information sources where the search is carried out;
a means of hierarchizing the results of the search, in each group of results corresponding to the various groups of information sources;
a means of separately displaying each group of results;
a means of determining the copying of an item of information from one source accessible on a network to another;
a means of assigning, to the source from which said information is copied, a higher weight than the source where a copy of said information is placed; and
a means of hierarchizing the results of the search; utilizing said weight of the source;
a means of determining a search context as a function of the input combination of keywords;
a means of determining a result context as a function of the content of the page;
a means of hierarchizing the results of the search as a function of the matching of the context of the search and of the context of each result of the search and
a means of displaying hierarchized results.

In some variants, a step of selecting sources of information organized by country in a plurality of groups, for example at least five, and a step of displaying information according to the groups selected, are performed.

In some variants, interactivity and a hierarchy between the groups of information are organized by weighting the results.

In some variants, an independent sub-search can be performed in each of the groups, while maintaining a hierarchy between the groups.

In some variants, it is possible to change the filtering realized by the user (by country, for example) in order to be able to perform searches according to different viewpoints.

In some variants, during at least one hierarchization step, the additional item of information corresponds to profiling of a user type according to certain parameters, e.g. sex, age, etc.

In some variants, during the step of selecting an additional item of information, the user selects a search result, the method comprising a step of determining the user's preferences as a function of his profile type and, during the second hierarchization step, each secondary keyword has a lower weight than the weight of each main keyword.

1-17. (canceled)

18. A system of rapid provision of relevant information, comprising:
a network;
a plurality of terminals, each terminal associated with a user and comprising a screen for displaying a user interface for receiving a plurality of keywords inputted by the user; and
a server connected to the network and comprising a search engine that provides the user interface to display on the screen of said each terminal; determines a search context as a function of a combination of keywords inputted by a user and received from a terminal associated with the user over the network; searches for pages comprising at least one word associated with at least one keyword inputted by the user and accessible on the network; determines a result context as a function of content of a page; determines whether an item of information from an information source accessible on the communications network is copied from another information source accessible on the network; assigns a higher weight to the information source from which the item of information is copied from than the information source where a copy of the item of information is placed; hierarchizes results of the search as a function of matching of context of the search, of context of each result of the search and of the weight of the information source; and displays hierarchized results on the screen of the terminal associated with the user; and
wherein the information source is one of a plurality of internet servers, on-line newspaper site servers, social network servers, or on-line commerce site servers.

19. The system according to claim 18, wherein the search engine determines the context of a result as a function of content of the page of said result.

20. The system according to claim 18, wherein the search engine determines the context of a result as a function of the information source hosting the page of said result.

21. The system according to claim 18, wherein the search engine determines the search context by weighting of main keywords.

22. The system according to claim 18, wherein the search engine determines the copying of the item of information by memorizing the item of information, a time-stamp associated with the item of information and the information source of the item of information from which access to the item of information was obtained; and by comparing the memorized information to detect similarities between two items of information and assigning a higher weight to the information source associated with an earliest time-stamp for similar items of information.

23. The system according to claim 22, wherein the search engine detects similarities as a function of a number of successive similar characters between the two items of information.

24. The system according to claim 22, wherein the search engine detects similarities as a function of a level of similar words between the two items of information.

25. The system according to claim 22, wherein the search engine detects similarities as a function of a number of successive similar characters between the two items of information and a distance between similar words.

26. The system according to claim 18, wherein the search engine assigns to the information source from which the information was copied, an increasing, non-constant function of a determined number of copies of the item of information.

27. The system according to claim 18, wherein the search engine organizes a plurality of information sources accessible on the network into groups; receives at least one keyword inputted by the user on the user interface from the terminal associated with the user over the network; searches for pages comprising at least one word associated with said at least one keyword simultaneously in each group of information sources; organizes results of the search in accordance with an affiliated group of an information source from which each result is obtained; hierarchizes the results of the search within each group as a function of the weight of the information sources; and separately displays the results for each group of information sources on the screen of the terminal associated with the user.

28. The system according to claim 27, wherein the search engine organizes said plurality of information sources as a function of information present on each information source.

29. The system according to claim 18, wherein search engine receives additional item of information selected by the user on the user interface from the terminal associated with the user over the network; hierarchizes the results of the search in accordance with said additional item of information; and displays the hierarchized results of the search having a high hierarchical level on the screen of the terminal associated with the user.

30. The system according to claim 29, wherein said additional item of information matches at least one keyword with a lower weight than the weight of each main keyword.

31. The system according to claim 29, wherein the search engine receives a search result selected by the user on the user interface from the terminal associated with the user over the network; and determines secondary keywords as a function of the selected search result, each secondary keyword having a lower weight than the weight of each main keyword.

32. The system according to claim 18, wherein the search engine organizes a plurality of information sources accessible on the network into groups; organizes results of the search in accordance with an affiliated group of an information source searched; hierarchizes the results of the search within each group as a function of the weight of the information sources; and separately displays the results for each group of information sources on the screen of the terminal associated with the user.

33. The system according to claim 32, wherein the search engine organizes said plurality of information sources as a function of information present on each information source.
